(19) United States
(12) Patent Application Publication
(10) Pub. No.: US 2021/0257206 A1
(43) Pub. Date: Aug. 19, 2021

(54) A PLASMA LIGHT SOURCE WITH LOW METAL HALIDE DOSE

(71) Applicant: CERAVISION LIMITED, Milton Keynes (GB)

(72) Inventors: Stuart MUCKLEJOHN, Wigston Magna (GB); Barry PRESTON, Melton Mowbray (GB)

(21) Appl. No.: 16/973,090

(22) PCT Filed: Jun. 7, 2019
(86) PCT No.: PCT/GB2019/051604

§ 371 Date: Dec. 8, 2020

(30) Foreign Application Priority Data
Jun. 8, 2018 (GB) 1809479.7

(51) Int. Cl. H01J 61/18; H01J 61/36; H01J 65/04

(52) U.S. Cl. CPC H01J 61/18; H01J 65/044; H01J 61/366

(57) ABSTRACT

A low-dose, preferably unsaturated, fill of microwave excitable material (9), including at least two metal halides in a noble gas with an optional mercury buffer, is contained in a plasma crucible (2) to form a light emitting plasma therein.

### BACKGROUND OF THE INVENTION

### Field of the Invention

The present invention relates to a plasma light source.

### Related Art

In this specification the following terminology is used:

“Light source” means an actual emitter of light, together with closely associated components for controlling spread of light;
“Luminaire” means a complete light unit, including a light source.

U.S. Pat. No. 5,864,210 (“the Matsushita Patent”) has the following abstract: “The apparatus has a light transmitting bulb for confining a discharge therein, a fill sealed within the light transmitting bulb and including a rare gas and a metal halide emitting a continuous spectrum by molecular radiation, and a discharge excitation source for applying electrical energy to the fill and for starting and sustaining an arc discharge, and the metal halide includes one kind of halide selected from the group consisting of an indium halide, a gallium halide, and a thallium halide, or a mixture thereof and in that the light transmitting bulb has no electrodes exposed in discharge space and further this construction utilizes the continuous spectrum of molecular radiation of the metal halide and thereby achieves high color rendering properties and high luminous efficacy simultaneously without using mercury as the fill.”

The desirability of the quantity of halides being equal to or greater than 0.5×10-5 mol/cm of internal dimension is stressed. In particular this internal dimension is defined as the inner wall-to-wall distance in the direction of the electric field of the electrical energy applied to excite the discharge. Also the presence of a quantity of zinc equal to or greater than 5×10-5 mol/cm of internal dimension is recommended. It is said to contribute to internal pressure in the bulb.

This bulb produces a broad spectrum light as shown in the Matsushita Patent's FIG. 1, reproduced in FIG. 1 of this specification.

The Matsushita Patent speaks of quantities of halides in mol/cm of wall to wall distance in the direction of the electric field. In the context of the Matsushita Patent, this is straightforward in that the bulb is circular. In our work, the cavities that we establish discharges in are circular cylindrical. For the avoidance of doubt, we measure the distance in the length of the circular cylindrical cavities.

### SUMMARY OF THE INVENTION

In tests we have attempted to improve on the Matsushita Patent for horticultural use for example, where a strong blue and UV region of the spectrum is advantageous. This is surprising in view of the teaching that metal halide molecular radiation is broad spectrum across the visible range. This teaching is not only in the above patent but also for instance at https://en.wikipedia.org/wiki/Metal-halide_lamp, which states:

“Metal-halide lamps have high luminous efficacy of around 75-100 lumens per watt, which is about twice that of mercury vapor lights and 3 to 5 times that of incandescent lights and produce an intense white light.”

It appears to us that the teaching of the above patent and the Wikipedia abstract does not apply to metal halides in the low concentrations that we have been testing. In these we get different results from those suggested.

Before setting out our invention, which has been made in research into improved horticultural lights, although it is not restricted to such lights and we expect that our improved lights will be used in other applications for UV lights, we reproduce a plot of solar radiation, as seen in FIG. 2 of this specification.

This shows:
UV, visible light and infra-red (“IR”) radiation both as it reaches the outer atmosphere and as it reaches sea level. The difference is significant in that plants which have evolved in mountains receive more of certain radiation than they do when grown at sea level. The biggest difference is in the UV range;
Minimal UV at sea level below c. 300 nm, the atmosphere absorbing all of it;
At the transition to visible light approximately 50% of incident UV is absorbed at sea level;
At a little over 400 nm, there is still a marked absorption of incident blue light.

The object of the present invention is to provide a light source providing an enhanced of radiation at the blue end of the spectrum, including into ultraviolet (“UV”) wavelengths, with a view to a supplementing ambient light with atmospherically absorbed light and supplementing artificial light having little or no emission in the UV and/or blue region.

According to a first aspect of the invention there is provided a plasma light source comprising:
a lucent envelope or a lucent crucible or fabrication having:
   a sealed void containing
   material excitable as a plasma, including
      at least two metal halides and
      an inert gas;
         the two metal halides together being provided in a concentration in use of less than 5.0×10-6 mol/cm of an inner wall-to-wall distance within the void with electrical energy being applied to excite the discharge with its electric field being in the direction of the wall-to-wall distance.

For the avoidance of doubt, we have measured the wall-to-wall distance along the length of the void, for instance along the length of the sealed plasma void, as described in our International Patent Application No. WO 2010/133822, of which the abstract is as follows:

“For operation in the TMO1O mode at 2450 MHz, a lucent crucible of quartz is 4.9 cm in diameter and 2.1 cm in length. A sealed plasma void is placed centrally on the central axis, with an antenna re-entrant at one end, but offset from the central axis of the crucible and close to the central void.”

It should be specifically noted that the concentration of halides is such that the vapour within the void is unsaturated in use. In other words there is no liquid pool. This results we believe in strong molecular radiation as well as atomic radiation.

Preferably the lucent envelope will be a lucent tube sealed at its ends to provide the sealed void, the length of the tube being in the direction of the wall-to-wall distance. Normally, the lucent envelope will be provided within a central longitudinal bore in a separate lucent body. It can be fixedly provided within the bore in the separate lucent body.

Alternatively, the lucent crucible can be a body of lucent material having a sealed, central longitudinal bore which provides the sealed void, the length of the bore being in the direction of the wall-to-wall distance.

The crucible can be as described in our above Application No. WO 2010/133822.

Normally in use, the crucible or the lucent body will be enclosed by:
an HF electromagnetic-wave-enclosing Faraday cage:
   surrounding the crucible on an outside and an end thereof and
   being at least partially light transmitting for light exit from the plasma crucible,
      the arrangement being such that light from a plasma in the void can pass through the plasma crucible and radiate from it via the cage.

The Faraday cage can be as described in our above Application No. WO 2010/133822.

We have found that the following noble gases are suitable for use as the inert gas: neon (Ne), argon (Ar), krypton (Kr), xenon (Xe).

We have also included Hg in the fill as a buffer.

We have tested a variety metal halides and results suggest that they can be chosen from fluorides, chlorides, bromides and iodides. For practical purposes, fluorides can only be used in plasma crucibles made of ceramic material.

We believe that the following metals are suitable as halides for our light sources:

Al, As, Bi, Cd, Ga, Ge, In, Nb, Pb, Sb, Sn, Ti, Tl, V, Zn.

We recognise that current environmental regulations would preclude use of Cd and Pb in products placed on the market.

The limits for the total metal halide content of the plasma crucible, which we believe to be feasible, are between 1.60×10⁻⁸ and 4.99×10⁻⁶ mol/cm of the inner wall-to-wall distance in the direction of the electric field of the electrical energy applied to excite the discharge.

Our preferred range is between 4.10×10⁻⁸ and 1.85×10⁻⁶ mol/cm.

Our preferred range for the inert gas content of the plasma crucible are between 1.00×10⁻⁸ and 3.25×10⁻⁶ mol/cm of the wall-to-wall distance in the direction of the electric field of the electrical energy applied to excite the discharge.

Our preferred range for the buffer, i.e. Hg, content of the plasma crucible are between 1.25×10⁻⁶ and 1.25×10⁻⁶ mol/cm of the wall-to-wall distance in the direction of the electric field of the electrical energy applied to excite the discharge.

We expect the range to be between 1.2×10⁻⁵ and 7.5×10⁻⁵ mol/cm.

### BRIEF DESCRIPTION OF THE DRAWINGS

To help understanding of the invention, a specific embodiment thereof and variations will now be described by way of example and with reference to the accompanying drawing, in which:

FIG. 1 is a graph showing a broad spectrum of light produced by a bulb, such as used in U.S. Pat. No. 5,864,210;

FIG. 2 is a plot of solar radiation showing UV, visible and infra-red radiation both as it reaches the outer atmosphere and as it reaches sea level;

FIG. 3 is a perspective view of a lucent plasma crucible of the invention;

FIG. 4 is a cross-sectional view of a lucent envelope and body, such as used in WO 2014/045044, which can be used in a variant of the invention, the view is FIG. 5 of WO 2014/045044;

FIG. 5 is a similar cross-sectional view of another lucent envelope and body, such as used in WO 2015/189632, which can be used in another variant of the invention, the view is FIG. 1 of WO 2015/189632;

FIG. 6 is the output spectral power distribution between 300 nm to 550 nm for example A;

FIG. 7 is the output spectral power distribution between 300 nm to 1100 nm for example A;

FIG. 8 is the output spectral power distribution between 300 nm to 550 nm for example B;

FIG. 9 is the output spectral power distribution between 300 nm to 1100 nm for example B;

FIG. 10 is the output spectral power distribution between 300 nm to 550 nm for example C;

FIG. 11 is the output spectral power distribution between 300 nm to 1100 nm for example C;

FIG. 12 is the output spectral power distribution between 300 nm to 550 nm for example D;

FIG. 13 is the output spectral power distribution between 300 nm to 1100 nm for example D;

FIG. 14 is the output spectral power distribution between 300 nm to 550 nm for example E;

FIG. 15 is the output spectral power distribution between 300 nm to 1100 nm for example E;

FIG. 16 is the output spectral power distribution between 300 nm to 550 nm for example G;

FIG. 17 is the output spectral power distribution between 300 nm to 1100 nm for example G;

FIG. 18 is the output spectral power distribution between 300 nm to 550 nm for example H;

FIG. 19 is the output spectral power distribution between 300 nm to 1100 nm for example H.

### DETAILED DESCRIPTION OF THE PREFERRED EMBODIMENT

Referring to FIG. 3, a light source 1 to be powered by microwave energy is shown. It is similar to that described in our WO 2010/133822, whose abstract is quoted above. The source has a circularly cylindrical body 2 of quartz, forming a solid plasma envelope or crucible. Quartz is transparent to visible light and the outer surfaces of the quartz are polished. The crucible could be of translucent ceramic such as alumina. We use “lucent” to mean either transparent or translucent. The crucible has a length 1 and a diameter d. Aligned centrally is a void 3. It is short and of small diameter with respect to the dimensions of the crucible itself. The void is sealed by working of the material of the crucible or an additional piece of quartz. Methods of sealing are described in our International application WO 2010/094938.

A Faraday cage 4 surrounds the curved side surface 5 and one end surface 6 of the crucible. It can be of metallic mesh or reticular metallic sheet, such that the majority of light passing out of the crucible at these surfaces passes through the cage, whilst microwaves cannot. A band 7 of the cage extends around an end of a carrier 8 to which the cage is fastened, thereby carrying the crucible.

A fill of microwave excitable material 9, of metal halide with a mercury buffer in a noble gas, is contained to form a light emitting plasma therein An antenna 10 is arranged in a bore 11 extending within the plasma crucible for transmitting plasma-inducing microwave energy to the fill. The antenna has a connection 12 extending outside the plasma crucible for coupling to a source of microwave energy 14—the source being shown diagrammatically. Details of such a source and means for feeding microwave energy into the connection are described in International patent application WO 2010/128301.

More recently, as described in our WO 2014/045044 and WO 2015/189632, we have moved from a quartz crucible having an excitable material envelope secured within it to an envelope fixed or free within the crucible, which we have described as a lucent body as opposed to a crucible as such. The body has remained sized for microwave resonance.

FIG. 4 is a FIG. 5 of WO 2014/045044, whose abstract is as follows—albeit with altered reference numerals:

A crucible 101 for a LUWPL is formed from a wave guide body 102 having a central bore 103 through it. Received within the central bore is a drawn quartz tube 104, having its ends sealed, one 141 having been worked flat to be coplanar with one face 121 of body. The other end 142 has a vestigial tip 143. This is secured to the body at the orifice 122 of the bore in the other face 123 of the body. The securement is by means of ceramic adhesive compound 105.

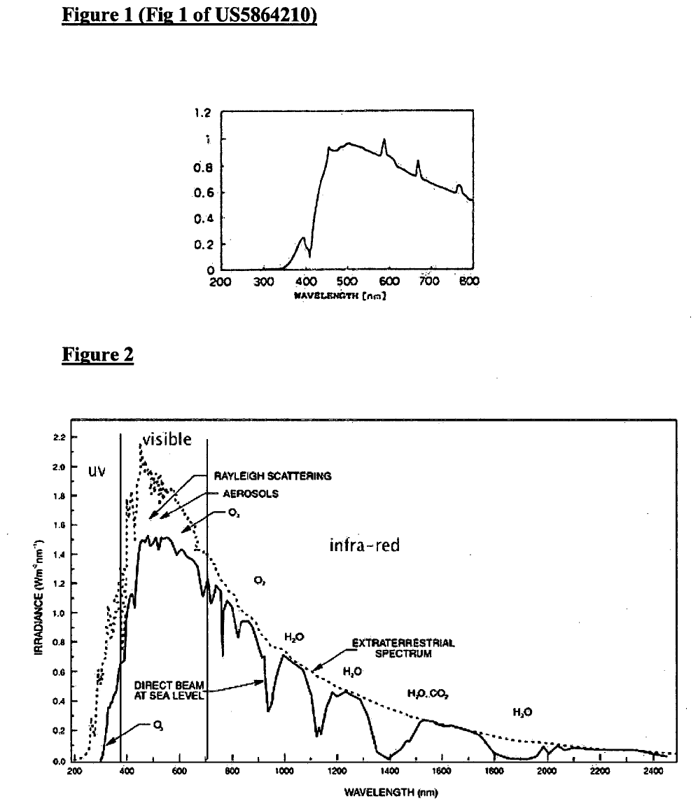

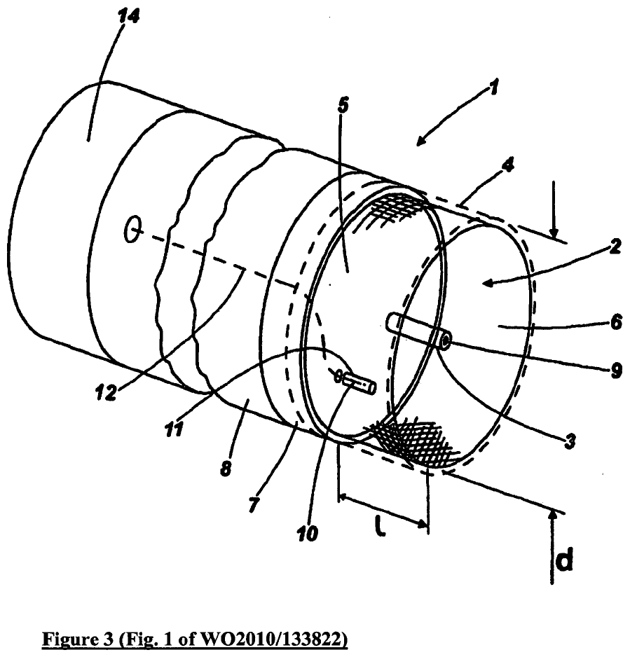

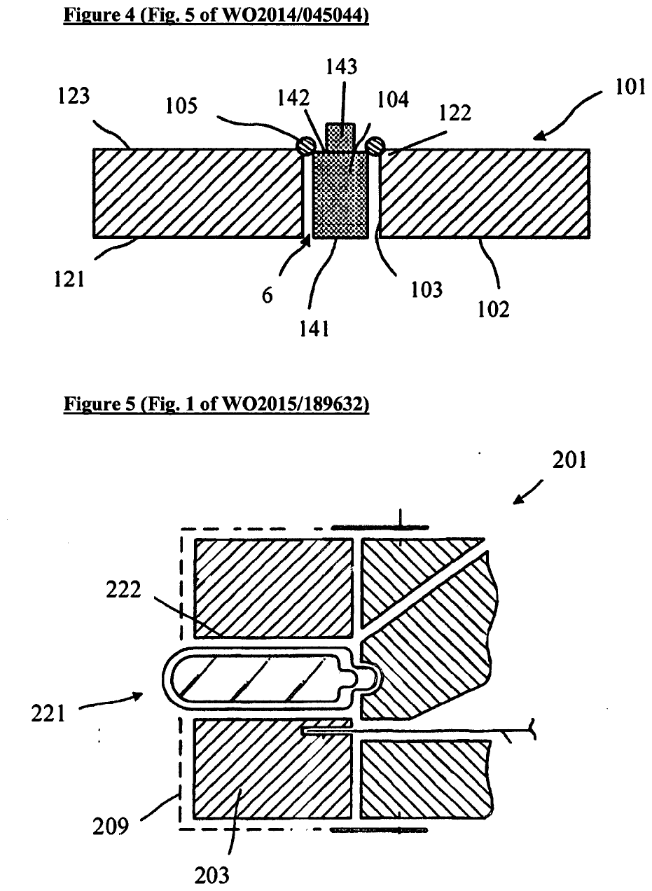

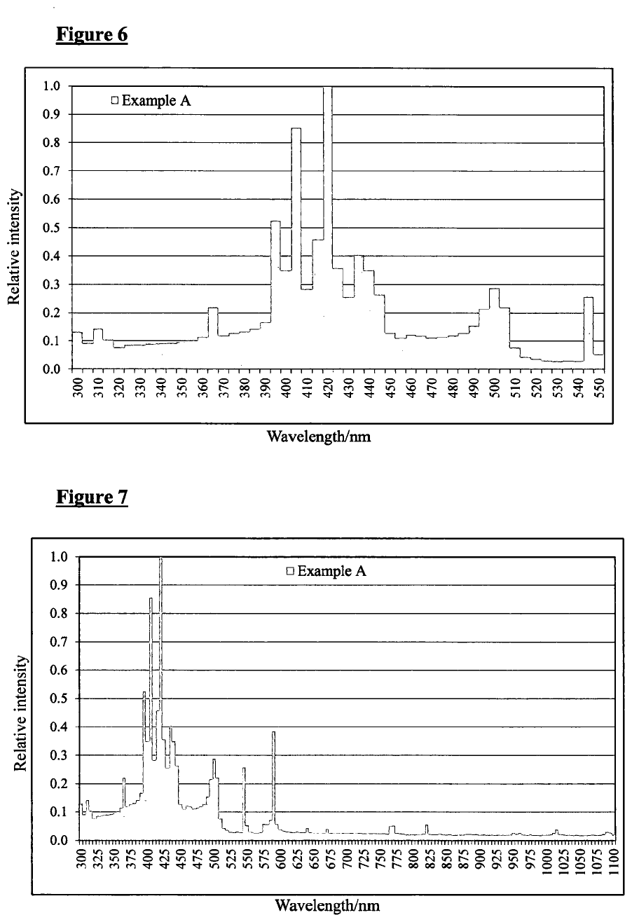

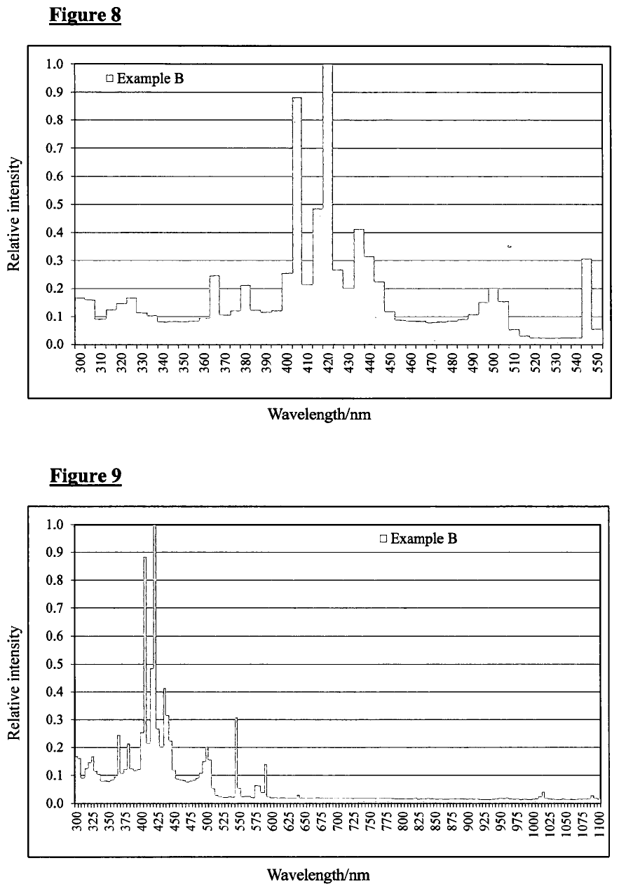

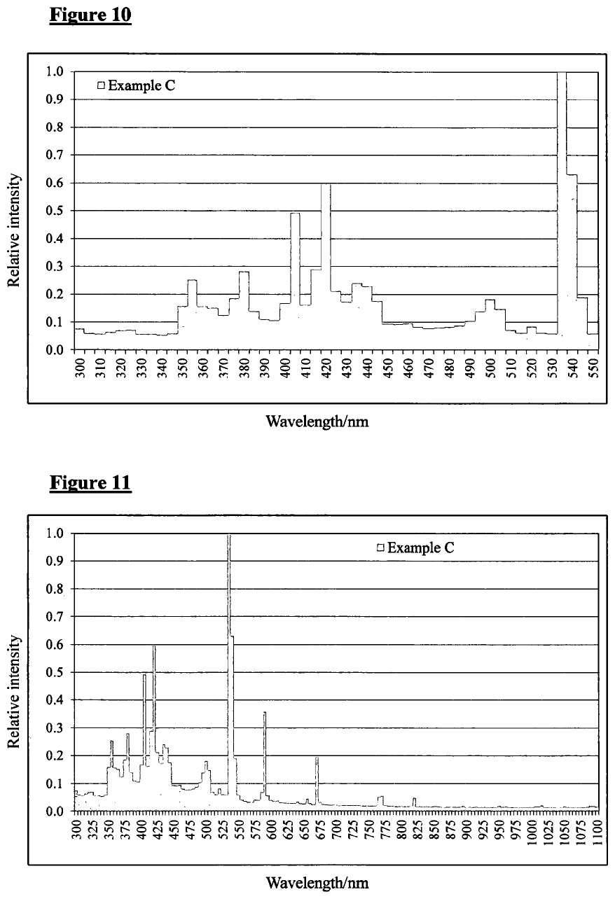

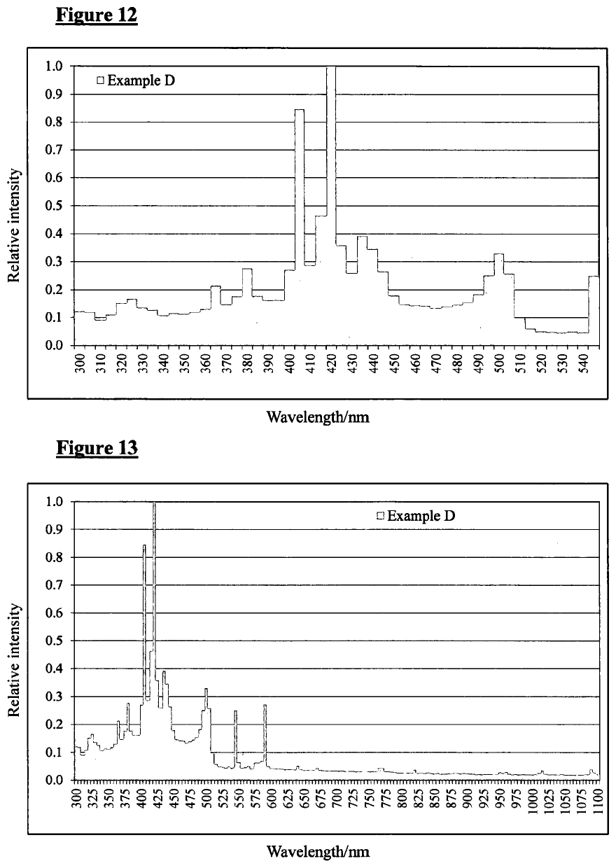

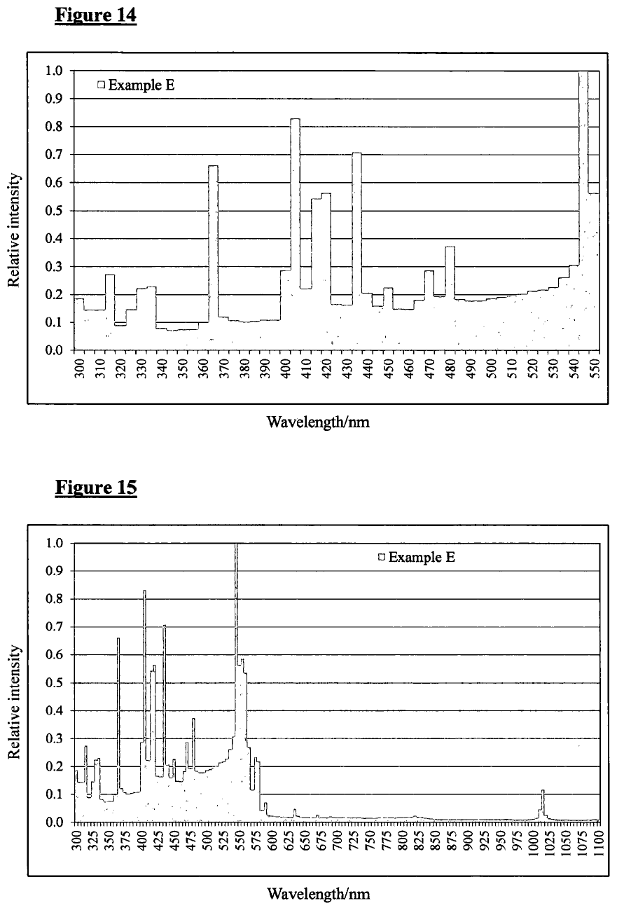

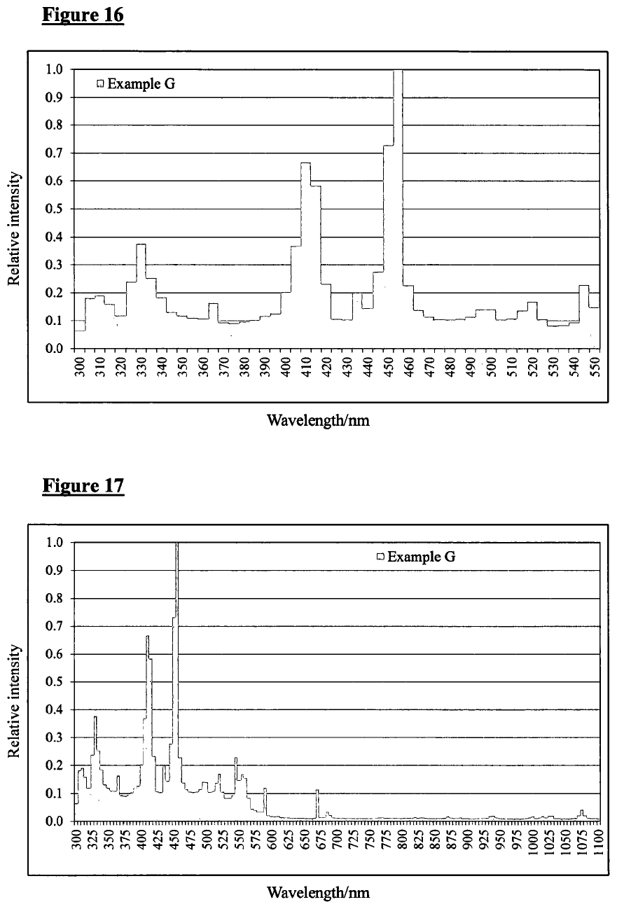

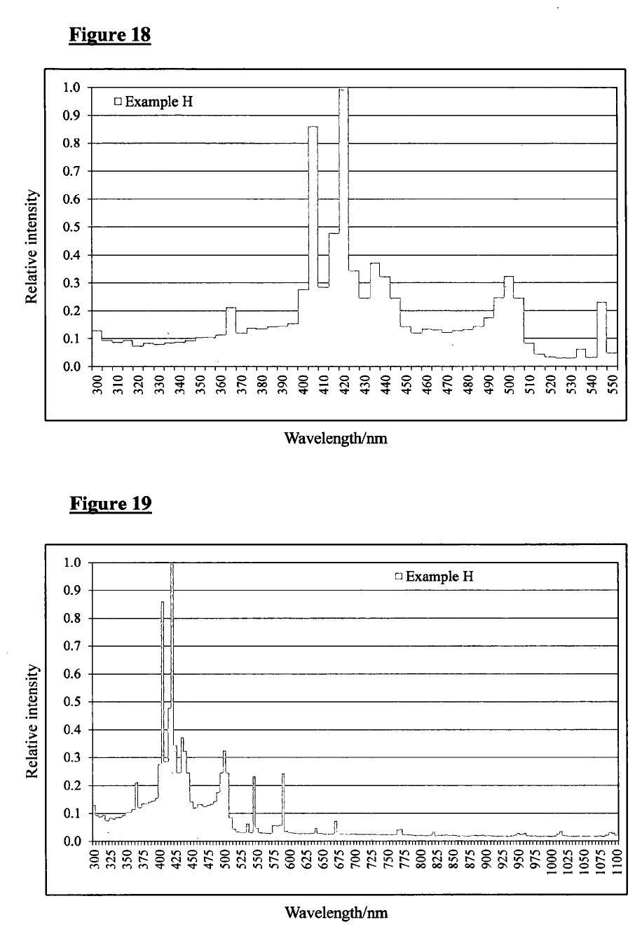

FIG. 5 is a FIG. 1 of WO 2015/189632, whose abstract is as follows—albeit with altered reference numerals:

A light source 201 to be powered by microwave energy, having a dielectric body 203 or fabrication of material lucent for exit of light therefrom, a receptacle 222 within the dielectric body or fabrication, and a lucent microwave-enclosing Faraday cage 209 surrounding the dielectric body or fabrication. The dielectric body or fabrication within the Faraday cage forms at least part of a microwave resonant cavity. A sealed plasma enclosure 221 of lucent material within the receptacle 222 has a means—not visible—for locating the plasma enclosure within the receptacle with respect to the dielectric body or fabrication.

In the language of the present application, the “enclosure” and the “receptacle” of WO 2014/045044 are the present envelope and bore in the body.

For the avoidance of doubt, the lucent bodies and envelopes of WO 2014/045044 or WO 2015/189632 can be used with the fills of the present invention, as exemplified below.

Further for the avoidance of doubt, the wall-to-wall distance in the direction of the applied electric field is the internal distance in the length l in FIG. 1 and the equivalent directions and distance in the lucent bodies and envelopes of WO 2014/045044 or WO 2015/189632.

In the latter case, the envelope can be provided with means location means such as in that application, i.e. fused on lugs locating in recesses in the body from the bore. Alternatively the bore can be and the envelope can be plain with other location means provided.

In the following examples of lucent crucibles in which we have lit plasmas, we use quartz, which has a dielectric constant of 3.78, as the material of the lucent crucible and we operate at a frequency of 2,450 MHz.

At an input power of approximately 265 W, we have tested the performance of plasma crucibles containing mixtures of:

| Example A | mol/cm |
|---|---|
| SbI₃ | 1.99 × 10⁻⁷ |
| GaBr₃ | 3.20 × 10⁻⁷ |
| AlI₃ | 2.45 × 10⁻⁷ |
| Total metal halides | 7.55 × 10⁻⁷ |
| Hg | 3.69 × 10⁻⁵ |
| Xe | 1.87 × 10⁻⁸ |

| Example B | mol/cm |
|---|---|
| SbI₃ | 1.99 × 10⁻⁷ |
| GaBr₃ | 3.20 × 10⁻⁷ |
| AlBr₃ | 3.75 × 10⁻⁷ |
| Total metal halides | 8.94 × 10⁻⁷ |
| Hg | 3.69 × 10⁻⁵ |
| Xe | 1.87 × 10⁻⁸ |

| Example C | mol/cm |
|---|---|
| SbI₃ | 1.99 × 10⁻⁷ |
| GaBr₃ | 3.20 × 10⁻⁷ |
| TlI | 1.60 × 10⁻⁷ |
| Total metal halides | 6.69 × 10⁻⁷ |
| Hg | 3.69 × 10⁻⁵ |
| Xe | 1.87 × 10⁻⁸ |

| Example D | mol/cm |
|---|---|
| SbI₃ | 1.99 × 10⁻⁷ |
| GaBr₃ | 3.23 × 10⁻⁷ |
| SnI₂ | 1.34 × 10⁻⁷ |
| Total metal halides | 6.47 × 10⁻⁷ |
| Hg | 3.69 × 10⁻⁵ |
| Xe | 1.87 × 10⁻⁸ |

| Example E | mol/cm |
|---|---|
| GaCl₃ | 2.84 × 10⁻⁷ |
| ZnCl₂ | 4.40 × 10⁻⁷ |
| Total metal halides | 7.24 × 10⁻⁷ |
| Hg | 3.69 × 10⁻⁵ |
| Xe | 1.87 × 10⁻⁸ |

| Example G | mol/cm |
|---|---|
| GaCl₃ | 2.84 × 10⁻⁷ |
| InCl | 3.33 × 10⁻⁷ |
| Total metal halides | 6.17 × 10⁻⁷ |
| Hg | 3.69 × 10⁻⁵ |
| Xe | 1.87 × 10⁻⁸ |

| Example H | mol/cm |
|---|---|
| GaBr₃ | 8.10 × 10⁻⁷ |
| SbI₃ | 4.78 × 10⁻⁷ |
| Total metal halides | 1.29 × 10⁻⁶ |
| Hg | 3.69 × 10⁻⁵ |
| Xe | 1.87 × 10⁻⁸ |

Summary of output 300 to 550 nm and 300 to 1100 nm at capsule input power of 265 W

| | Output/W | Output/W |
|---|---|---|
| Example | 300 to 550 nm | 300 to 1100 nm |
| Example A | 57.9 | 77.3 |
| Example B | 57.5 | 72.9 |
| Example C | 61.9 | 84.2 |
| Example D | 60.3 | 81.5 |
| Example E | 61.6 | 79.6 |
| Example G | 63.4 | 76.7 |
| Example H | 62.0 | 81.8 |

| | | | | | | | | |
|---|---|---|---|---|---|---|---|---|
| Example | Capsule | [symbol] | [symbol] | Ratio | Blue [symbol] | UV-A [symbol] | UV-B [symbol] | Blue + UV [symbol] |

Rank by

[symbol]

| | | | | | | | | | |
|---|---|---|---|---|---|---|---|---|---|
| Example_G | [symbol] | [symbol] | [symbol] | [symbol] | [symbol] | [symbol] | [symbol] | [symbol] | [symbol] |
| Example_H | [symbol] | 81.81 | [symbol] | 0.76 | [symbol] | [symbol] | [symbol] | [symbol] | [symbol] |
| Example_C | [symbol] | 84.17 | [symbol] | 0.74 | [symbol] | [symbol] | [symbol] | [symbol] | [symbol] |
| Example_E | [symbol] | 79.64 | [symbol] | 0.77 | [symbol] | [symbol] | [symbol] | [symbol] | [symbol] |
| Example_D | [symbol] | 81.47 | [symbol] | [symbol] | [symbol] | [symbol] | [symbol] | [symbol] | [symbol] |
| Example_A | [symbol] | [symbol] | [symbol] | [symbol] | [symbol] | [symbol] | [symbol] | [symbol] | [symbol] |
| Example_B | [symbol] | [symbol] | [symbol] | [symbol] | [symbol] | [symbol] | [symbol] | [symbol] | [symbol] |

Rank by “Blue”

[symbol]

| | | | | | | | | | |
|---|---|---|---|---|---|---|---|---|---|
| Example_H | [symbol] | 81.81 | [symbol] | 0.76 | [symbol] | [symbol] | [symbol] | [symbol] | [symbol] |
| Example_G | [symbol] | [symbol] | [symbol] | [symbol] | [symbol] | [symbol] | [symbol] | [symbol] | [symbol] |
| Example_D | [symbol] | 81.47 | [symbol] | 0.74 | [symbol] | [symbol] | [symbol] | [symbol] | [symbol] |
| Example_A | [symbol] | [symbol] | [symbol] | [symbol] | [symbol] | [symbol] | [symbol] | [symbol] | [symbol] |
| Example_B | [symbol] | [symbol] | [symbol] | 0.79 | [symbol] | [symbol] | [symbol] | [symbol] | [symbol] |
| Example_E | [symbol] | [symbol] | [symbol] | 0.77 | [symbol] | [symbol] | [symbol] | [symbol] | [symbol] |
| Example_C | [symbol] | 84.17 | [symbol] | [symbol] | [symbol] | [symbol] | [symbol] | [symbol] | [symbol] |

Rank by “UV-A”

| | | | | | | | | | |
|---|---|---|---|---|---|---|---|---|---|
| Example_G | [symbol] | 76.70 | [symbol] | [symbol] | [symbol] | [symbol] | [symbol] | [symbol] | [symbol] |
| Example_C | [symbol] | [symbol] | [symbol] | 0.74 | [symbol] | [symbol] | [symbol] | [symbol] | [symbol] |
| Example_D | [symbol] | 81.47 | [symbol] | 0.74 | [symbol] | [symbol] | [symbol] | [symbol] | [symbol] |
| Example_A | [symbol] | 77.27 | [symbol] | 0.75 | [symbol] | [symbol] | [symbol] | [symbol] | [symbol] |
| Example_B | [symbol] | 72.89 | [symbol] | 0.79 | [symbol] | [symbol] | [symbol] | [symbol] | [symbol] |
| Example_H | [symbol] | 81.81 | [symbol] | [symbol] | [symbol] | [symbol] | [symbol] | [symbol] | [symbol] |
| Example_E | [symbol] | [symbol] | [symbol] | 0.77 | [symbol] | [symbol] | [symbol] | [symbol] | [symbol] |

Rank by “UV-B”

| | | | | | | | | | |
|---|---|---|---|---|---|---|---|---|---|
| Example_G | [symbol] | 76.70 | [symbol] | [symbol] | [symbol] | [symbol] | [symbol] | [symbol] | [symbol] |
| Example_E | [symbol] | [symbol] | [symbol] | [symbol] | [symbol] | [symbol] | [symbol] | [symbol] | [symbol] |
| Example_B | [symbol] | [symbol] | [symbol] | [symbol] | [symbol] | [symbol] | [symbol] | [symbol] | [symbol] |
| Example_A | [symbol] | 77.27 | [symbol] | [symbol] | [symbol] | [symbol] | [symbol] | [symbol] | [symbol] |
| Example_H | [symbol] | 81.81 | [symbol] | [symbol] | [symbol] | [symbol] | [symbol] | [symbol] | [symbol] |
| Example_D | [symbol] | 81.47 | [symbol] | [symbol] | [symbol] | [symbol] | [symbol] | [symbol] | [symbol] |
| Example_C | [symbol] | [symbol] | [symbol] | [symbol] | [symbol] | [symbol] | [symbol] | [symbol] | [symbol] |

Rank by “Blue + UV”

| | | | | | | | | | |
|---|---|---|---|---|---|---|---|---|---|
| Example_G | [symbol] | 76.70 | [symbol] | [symbol] | [symbol] | [symbol] | [symbol] | [symbol] | [symbol] |
| Example_H | [symbol] | [symbol] | [symbol] | [symbol] | [symbol] | [symbol] | [symbol] | [symbol] | [symbol] |
| Example_D | [symbol] | 81.47 | [symbol] | [symbol] | [symbol] | [symbol] | [symbol] | [symbol] | [symbol] |
| Example_B | [symbol] | [symbol] | [symbol] | [symbol] | [symbol] | [symbol] | [symbol] | [symbol] | [symbol] |
| Example_A | [symbol] | 77.27 | [symbol] | 0.75 | [symbol] | [symbol] | [symbol] | [symbol] | [symbol] |
| Example_E | [symbol] | [symbol] | [symbol] | 0.77 | [symbol] | [symbol] | [symbol] | [symbol] | [symbol] |
| Example_C | [symbol] | [symbol] | [symbol] | 0.74 | [symbol] | [symbol] | [symbol] | [symbol] | [symbol] |

[symbol]

indicates data missing or illegible when filed

The resulting spectra are show in FIGS. 6 & 7 (Example A), FIGS. 8 & 9 (Example B), FIGS. 10 & 11 (Example C), FIGS. 12 & 13 (Example D), FIGS. 14 & 15 (Example E), FIGS. 16 & 17 (Example G), FIGS. 18 & 19 (Example H). (NB there is no example F).

1. A plasma light source comprising:
a lucent envelope or a lucent crucible or fabrication having:
a sealed void containing material excitable as a plasma, including at least two metal halides and an inert gas;
the two metal halides together being provided in a concentration in use of less than 5.0×10⁻⁶ mol/cm of an inner wall-to-wall distance within the void with electrical energy being applied to excite the discharge with its electric field being in the direction of the wall-to-wall distance.

2. A plasma light source as claimed in claim 1, wherein the concentration of halides is such that the vapour within the void is unsaturated in use.

3. A plasma light source as claimed in claim 1, wherein there is no pool of excitable material in use.

4. A plasma light source as claimed in claim 1, wherein the lucent envelope is a lucent tube sealed at its ends to provide the sealed void, the length of the tube being in the direction of the wall-to-wall distance.

5. A plasma light source as claimed in claim 4, wherein the lucent envelope is provided within a central longitudinal bore in a separate lucent body.

6. A plasma light source as claimed in claim 5, wherein the lucent envelope is fixedly provided within the bore in the separate lucent body.

7. A plasma light source as claimed in claim 1, wherein the lucent crucible is a body of lucent material having a sealed, central longitudinal bore which provides the sealed void, the length of the bore being in the direction of the wall-to-wall distance.

8. A plasma light source as claimed in claim 5, wherein the crucibel or lucent body is enclosed by: an HF electromagnetic-wave-enclosing Faraday cage:
surrounding the crucible on an outside and an end thereof and being at least partially light transmitting for light exit from the plasma crucible,
the arrangement being such that light from a plasma in the void can pass through the plasma crucible and radiate from it via the cage.

9. A plasma light source as claimed in claim 1, wherein the inert gas is a noble gas or a mixture of noble gases, preferably chosen from: neon (Ne), argon (Ar), krypton (Kr), xenon (Xe).

10. A plasma light source as claimed in claim 1, wherein the fill sealed void further includes mercury as a buffer.

11. A plasma light source as claimed in claim 1, wherein the halides are chosen from chlorides, bromides and iodides and the lucent envelope or crucible is of quartz or ceramic.

12. A plasma light source as claimed in claim 1, wherein the halides are chosen from fluorides and the lucent envelope or crucible is ceramic material.

13. A plasma light source as claimed in claim 1, wherein the halides are chosen from the halides group consisting essentially of Al, As, Bi, Cd, Ga, Ge, In, Nb, Pb, Sb, Sn, Ti, Tl, V, and Zn.

14. A plasma light source as claimed in claim 1, wherein the total metal halide content of the plasma crucible is between 1.60×10⁻⁸ and 4.99×10⁻⁶ mol/cm of the inner wall-to-wall distance in the direction of the electric field of the electrical energy applied to excite the discharge.

15. A plasma light source as claimed in claim 14, wherein the total metal halide content is between 4.10×10⁻⁸ and 1.85×10⁻⁶ mol/cm.

16. A plasma light source as claimed in claim 1, wherein the inert gas content of the plasma crucible is between 1.00×10⁻⁸ and 3.25×10⁻⁶ mol/cm of the wall-to-wall distance in the direction of the electric field of the electrical energy applied to excite the discharge.

17. A plasma light source as claimed in claim 1, wherein the Hg buffer content of the plasma crucible is between 1.25×10⁻⁶ and 1.25×10⁻⁶ mol/cm of the wall-to-wall distance in the direction of the electric field of the electrical energy applied to excite the discharge.

18. A plasma light source as claimed in claim 17, wherein the Hg buffer content is between 1.2×10⁻⁵ and 7.5×10⁻⁵ mol/cm.
